(19) United States
(12) Patent Application Publication
(10) Pub. No.: US 2011/0138325 A1
(43) Pub. Date: Jun. 9, 2011

(54) APPARATUS AND METHOD FOR USER INTERFACE CONFIGURATION IN PORTABLE TERMINAL

(75) Inventor: Jae-Young YANG, Seoul (KR)

(73) Assignee: SAMSUNG ELECTRONICS CO. LTD., Suwon-si (KR)

(21) Appl. No.: 12/962,811

(22) Filed: Dec. 8, 2010

(30) Foreign Application Priority Data
Dec. 8, 2009 (KR) 10-2009-0120877

(51) Int. Cl. G06F 3/048

(52) U.S. Cl. 715/800

(57) ABSTRACT

A method and an apparatus for magnifying or reducing an application on one screen in a portable terminal are provided. In the method, a user is allowed to select an application to be magnified through a touch input command on a screen. The application to be magnified is executed on one screen using a short circuit technique. The executed application is magnified on the one screen according to the user's touch input. The executed application is driven on the one screen according to the user's touch input using the short circuit technique. The executed application is reduced on the one screen according to the user's touch input command.

### PRIORITY

This application claims the benefit under 35 U.S.C. §119(a) of a Korean patent application filed in the Korean Intellectual Property Office on Dec. 8, 2009 and assigned Serial No. 10-2009-0120877, the entire disclosure of which is hereby incorporated by reference.

### BACKGROUND OF THE INVENTION

1. Field of the Invention

The present invention relates to an apparatus and a method for configuring a user interface editable by a user in a portable terminal.

2. Description of the Related Art

A screen in a current portable terminal displays only information determined by a developer, and a display range is determined upon programming. For this reason, a user cannot configure the range of display.

In addition, in most portable terminals, an application is driven in a screen of 3 inches or less. Even when multi-tasking is supported by the portable terminal, only one application of a plurality of applications is displayed on the screen. That is, a user cannot view all of the plurality of applications currently in operation on one screen.

In addition, a widget may allow a plug-in program desired by a user to be freely displayed on the screen, but the plug-in program should abide by the interface of the widget itself so that it may be displayed. The plug-in program is not directly displayed, but hands over information to be displayed to a widget engine, and the widget engine analyzes this information to display the plug-in program.

Therefore, a need exists for an apparatus and a method for allowing a user to edit desired information on one screen at a time to view the information on the one screen in a portable terminal.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for configuring a user interface in a portable terminal.

Another aspect of the present invention is to provide an apparatus and a method for allowing a user to edit desired information on one screen at a time to view the information on the one screen in a portable terminal.

Still another aspect of the present invention is to provide an apparatus and a method for allowing a user to reduce/magnify in person a window of an application on a screen and display one or more desired applications simultaneously in a portable terminal.

In accordance with an aspect of the present invention, a method for magnifying or reducing an application on one screen in a portable terminal is provided. The method includes allowing a user to select an application to be magnified through a touch input command on a display screen, executing the application to be magnified on one screen using a short circuit technique, magnifying the executed application on the one screen according to the user's touch input command, driving the executed application on the one screen according to the user's touch input command using the short circuit technique, and reducing the executed application on the one screen according to the user's touch input command.

In accordance with another aspect of the present invention, an apparatus for magnifying or reducing an application on one screen in a portable terminal is provided. The apparatus includes a display unit for providing a screen output, and a widget service determining unit for allowing a user to select an application to be magnified through a touch input command on a display screen, executing the application to be magnified on one screen using a short circuit technique, magnifying the executed application on the one screen according to the user's touch input command, driving the executed application on the one screen according to the user's touch input command using the short circuit technique, and reducing the executed application on the one screen according to the user's touch input command.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is an illustration of an event flow according to an exemplary embodiment of the present invention;

FIG. 2 is a flowchart illustrating a screen magnification/reduction process on a screen of a portable terminal according to an exemplary embodiment of the present invention;

FIG. 3 is a flowchart illustrating a data input process when an application is executed via a partial screen in a portable terminal according to an exemplary embodiment of the present invention;

FIG. 4 is a block diagram illustrating a portable terminal according to an exemplary embodiment of the present invention;

FIGS. 5A through 5D are illustrations of a message magnification/reduction process according to an exemplary embodiment of the present invention; and

FIGS. 6A and 6B are illustrations of message application driving according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Exemplary embodiments of the present invention provide an apparatus and a method for configuring a user interface in a portable terminal.

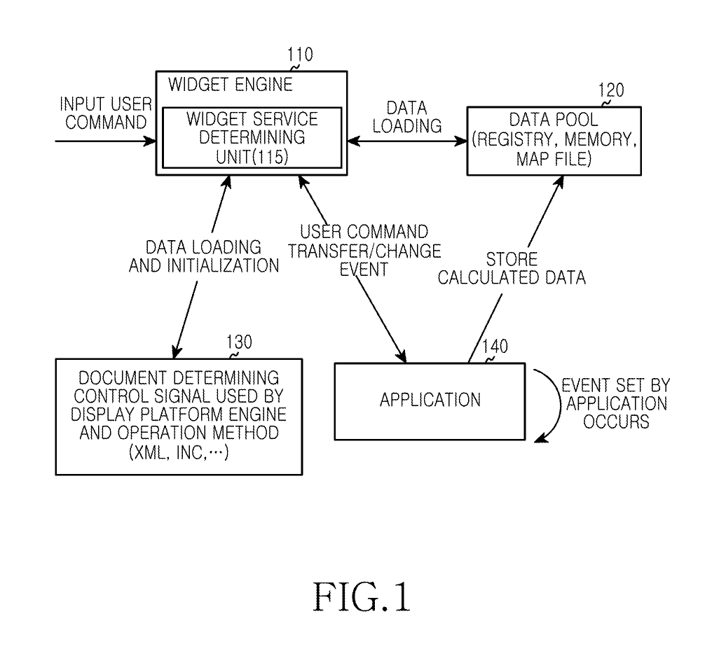

FIGS. 1 through 6B, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly state otherwise. A set is defined as a non-empty set including at least one element.

FIG. 1 is an illustration of an event flow according to an exemplary embodiment of the present invention.

Referring to FIG. 1, a widget service determining unit 115 is positioned at a widget engine 110, which is a display platform engine. In this structure, when an application 140 is executed, the widget engine 110 determines only a service required for the application 140 through a document (e.g., eXtension Markup Language (XML) or INClude (INC) file format) 130 that determines a control signal and an operation method to be used by the widget engine 110.

Thereafter, when an event for a set service occurs due to a user's input command during an operation of the application 140, the widget engine service determining unit 115 performs a relevant service to meet a service request, thereby raising an execution speed of the application 140. That is, the widget engine service determining unit 115 allows the application 140 to access the widget engine 110 via a short circuit. In addition, data 120 stored by the application 140 is loaded by the widget engine 110 when needed.

According to an exemplary embodiment of the present invention, a user reduces/magnifies in person a window of an application on a screen to display the same in a portable terminal.

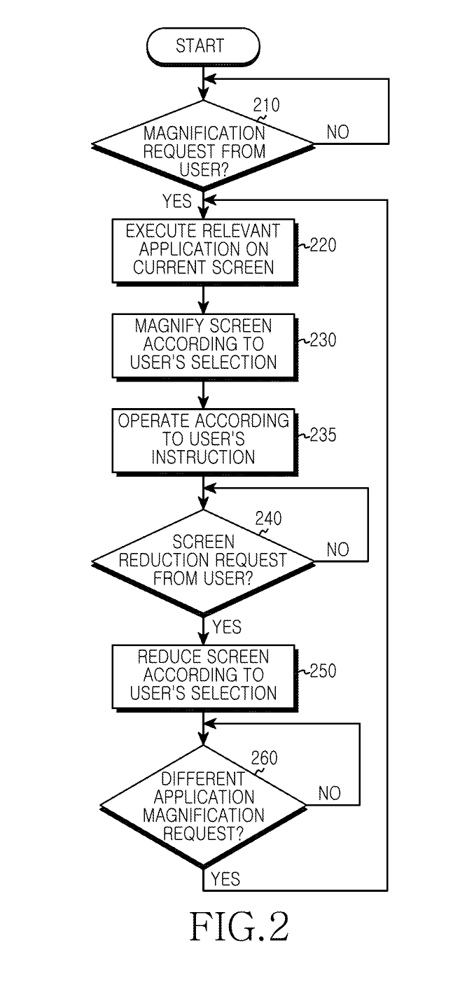

FIG. 2 is a flowchart illustrating a screen magnification/reduction process on a screen of a portable terminal according to an exemplary embodiment of the present invention.

Referring to FIG. 2, if it is determined that an application magnification request has been received from a user in step 210, the widget service determining unit executes the magnification of the requested application on a current screen in step 220.

In step 230, the widget service determining unit magnifies a screen of the application according to selection of a user's screen touch input. In step 235, the widget service determining unit and the application operate according to the user's touch input instruction.

Here, when the application operates, the widget service determining unit determines and sets a service required for executing the relevant application in advance. When an event for a set service occurs due to the user's input command, the widget service determining unit performs the relevant service to meet a service request, thereby raising an application execution speed. That is, the widget service determining unit allows the application to access the widget engine via a short circuit.

In step 240, if it is determined that an application screen reduction request has been received from the user, the widget service determining unit reduces the application screen according to the user's selection in step 250.

In step 260, if it is determined that a different application magnification request has been received from the user, the widget service determining unit executes the relevant application first on a current screen in step 220, and repeats the above-described subsequent steps.

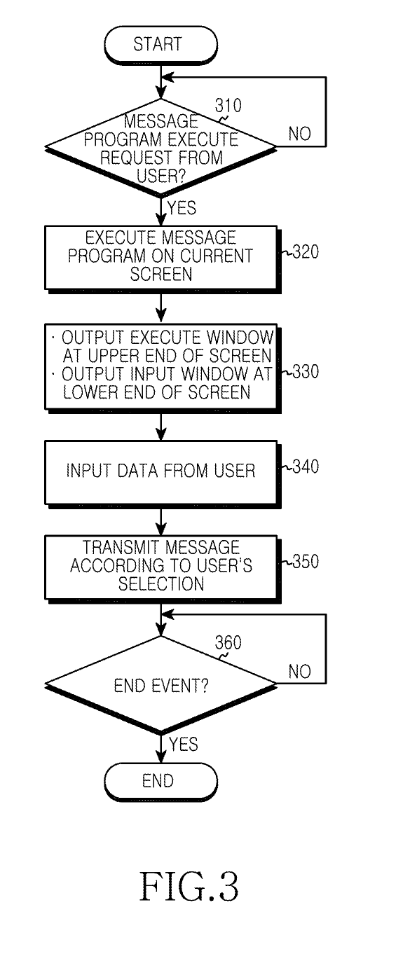

FIG. 3 is a flowchart illustrating a data input process when an application is executed via a partial screen in a portable terminal according to an exemplary embodiment of the present invention.

Referring to FIG. 3, if it is determined that a request to execute a message application has been received from a user in step 301, a widget service determining unit executes a message application whose execution has been requested on a current screen in step 320.

When the message application is executed, the widget service determining unit determines and sets a service required for executing the message application in advance from a widget engine. When an event for the set service occurs due to a user's input command, the widget service determining unit performs the relevant service to meet a service request, thereby raising a message application execution speed.

That is, the widget service determining unit allows the message application to access the widget engine through a short circuit. In addition, the widget service determining unit may magnify a screen of the message application according to the user's selection corresponding to the user's screen touch input.

In step 330, the widget service determining unit outputs a message application execute window at the upper end of the screen, and outputs a message application input window at the lower end of the screen.

In step 340, the widget service determining unit receives data from the user, and transmits the input message according to the user's selection in step 350.

If it is determined in step 360 that the user selects end of the message application and an end event occurs, the widget service determining unit ends the message application.

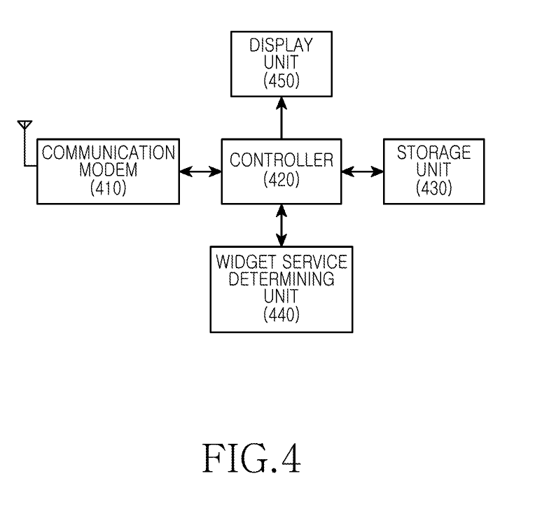

FIG. 4 is a block diagram illustrating a portable terminal according to an exemplary embodiment of the present invention.

Referring to FIG. 4, a portable terminal includes a communication modem 410, a controller 420, a storage unit 430, a widget service determining unit 440, and a display unit 450.

The communication unit 410 serves as a module for communicating with a different apparatus, and includes a radio processor and a baseband processor. The radio processor converts a signal received via an antenna into a baseband signal to provide the same to the baseband processor, and converts a baseband signal from the baseband processor into a radio signal, so that it can be transmitted on a radio path and transmits the signal via the antenna.

The controller 420 controls an overall operation of the portable terminal. For example, the controller 420 performs processes and controls for voice communication and packet communication. More particularly, according to an exemplary embodiment of the present invention, the controller 420 controls the widget service determining unit 440. In addition, according to an exemplary embodiment of the present invention, the controller 420 may provide the function of a widget manager.

The storage unit 430 stores programs for controlling an overall operation of the portable terminal and temporary data occurring during execution of the programs. More particularly, according to an exemplary embodiment of the present invention, the storage unit 430 stores a document that determines a control signal and an operation method to be used by a display platform engine.

The display unit 450 displays data output from the controller 420. In addition, though not shown in the drawing, the display unit 450 has a touch function, and input touch data is provided to the controller 420.

When requested by a user to execute a message application, the widget service determining unit 440 executes the message application whose execution has been requested first on a current screen. In addition, when the message application is executed, the widget service determining unit 440 determines and sets a service required for executing the message application in advance from a widget engine. When an event for the set service occurs due to a user's input command, the widget service determining unit 440 performs the relevant process to meet the service request, thereby raising a message application execution speed. That is, the widget service determining unit 440 allows the message application to access the widget engine through a short circuit. In addition, the widget service determining unit 440 may magnify the message application screen according to the user's selection corresponding to the user's screen touch input.

The widget service determining unit 440 outputs a message application execute window at the upper end of the screen, and outputs a message application input window at the lower end of the screen. The widget service determining unit 440 receives data from the user, and transmits the input message according to the user's selection. When the user selects end of the message application and an end event occurs, the widget service determining unit 440 ends the message application.

When requested by a user to execute a message application, the widget service determining unit 440 executes the message application whose execution has been requested on a current screen first. When the message application is executed, the widget service determining unit 440 determines and sets a service required for executing the message application in advance from a widget engine. When an event for the set service occurs due to the user's input command, the widget service determining unit 440 performs a relevant process to meet the service request, thereby raising the message application execution speed.

That is, the widget service determining unit 440 allows the message application to access the widget engine through a short-circuit. In addition, the widget service determining unit 440 may magnify the message application screen according to the user's selection corresponding to the user's screen touch input.

Thereafter, the widget service determining unit 440 outputs a message application execute window at the upper end of the screen, and outputs a message application input window at the lower end of the screen. The widget service determining unit 440 receives data from the user, and transmits the input message according to the user's selection.

When the user selects end of the message application and an end event occurs, the widget service determining unit 440 ends the message application.

In the above block configuration, the controller 420 may perform the function of the widget service determining unit 440. Separate configuration and illustration of the widget service determining unit 440 are for separately describing each function.

Therefore, in actual realization, all or some functions of the widget service determining unit 440 may be processed by the controller 420.

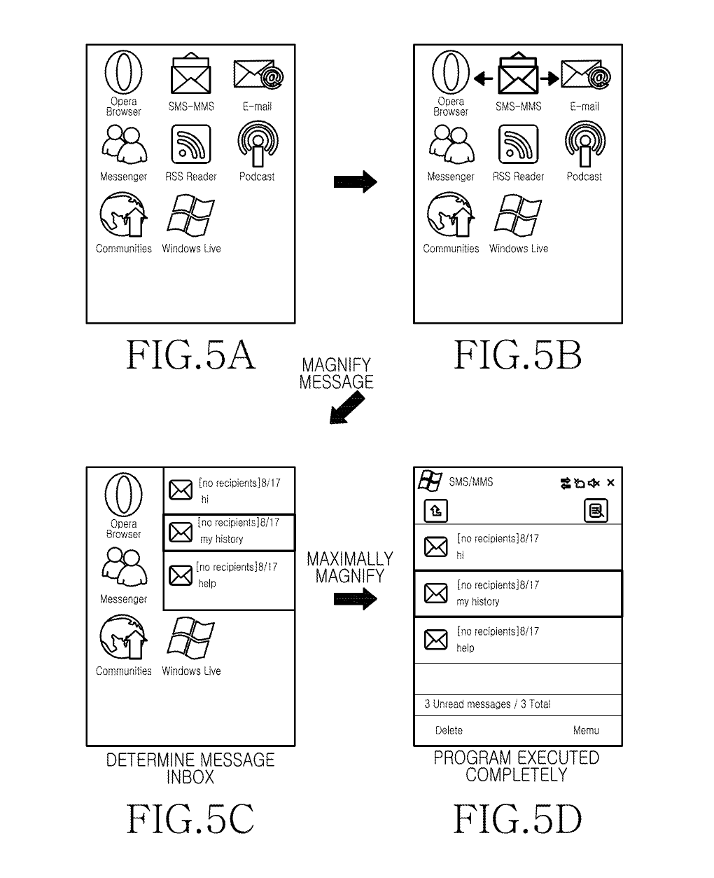

FIGS. 5A through 5D are illustrations of a message magnification/reduction process according to an exemplary embodiment of the present invention.

Referring to FIG. 5A, when a user selects a Short Messaging Service (SMS)-Multimedia Messaging Service (MMS) and, as in FIG. 5B, requests a portable terminal to magnify the SMS-MMS through a touch input command, the SMS-MMS is executed and magnified by the user's touch input command as in FIG. 5C.

When the user requests the portable terminal to magnify the entire SMS-MMS through touch input command, the SMS-MMS may be executed to an entire screen as in FIG. 5D.

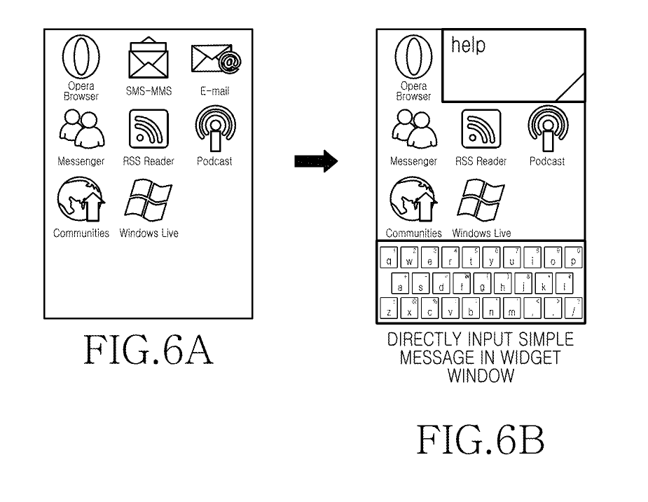

FIGS. 6A and 6B are illustrations of message application driving according to an exemplary embodiment of the present invention.

Referring to FIG. 6A, when a user selects an SMS-MMS and requests a portable terminal to input a message on the SMS-MMS execute screen, the user may immediately input a message into an SMS-MMS execute window at the upper end through an input window at the lower end as in FIG. 6B.

Compared to the program execute structure which only selects and executes a specific application in a portable terminal, an exemplary embodiment of the present invention may control the size of a window while the specific application is executed, and a user may control the size of an application being executed and display a plurality of applications on one screen even when the plurality of applications are executed.

In addition, in the related art, when a user reduces a window size of an application, only a partial screen of the application is displayed, which inconveniences the user. An exemplary embodiment of the present invention may display a desired screen, so that a user may use the application more conveniently.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for magnifying or reducing a first application on one screen in a portable terminal, the method comprising:
allowing a user to select the first application to be magnified through a touch input command on a display screen;
executing the first application to be magnified on one screen using a short circuit technique;
magnifying the executed first application on the one screen according to the user's touch input command;
driving the executed first application on the one screen according to the user's touch input command using the short circuit technique; and
reducing the executed first application on the one screen according to the user's touch input command.

2. The method of claim 1, further comprising:
magnifying the executed first application to a maximum size on the one screen according to the user's touch input command.

3. The method of claim 1, wherein the executing of the first application to be magnified on the one screen using the short circuit technique comprises, after determining a service used by the first application to be magnified in advance, meeting a request of the first application to be magnified.

4. The method of claim 1, wherein the driving of the executed first application on the one screen according to the user's touch input command using the short circuit technique comprises, after determining a service used by the executed first application in advance, meeting a request of the executed first application.

5. The method of claim 1, wherein the driving of the executed first application on the one screen according to the user's touch input command using the short circuit technique comprises, after determining a service used by the executed first application in advance, providing the user's touch input command to the executed first application.

6. The method of claim 1, further comprising:
allowing a user to select a second application to be magnified through a screen touch input command;
executing the second application to be magnified on one screen using the short circuit technique;
magnifying the executed second application according to the user's touch input command;
driving the executed second application on the one screen using the short circuit technique according to the user's touch input command; and
reducing the executed second application on the one screen according to the user's touch input command.

7. The method of claim 6, further comprising:
magnifying the executed second application to a maximum size on the one screen according to the user's touch input command.

8. The method of claim 6, wherein the executing of the second application to be magnified on the one screen using the short circuit technique comprises, after determining a service used by the second application to be magnified in advance, meeting a request of the second application to be magnified.

9. The method of claim 6, wherein the driving of the executed second application on the one screen using the short circuit technique according to the user's touch input command comprises, after determining a service used by the executed second application in advance, meeting a request of the executed second application.

10. The method of claim 6, wherein the driving of the executed second application on the one screen using the short circuit technique according to the user's touch input command comprises, after determining a service used by the executed second application in advance, providing the user's touch input command to the executed second application.

11. An apparatus for magnifying or reducing a first application on one screen in a portable terminal, the apparatus comprising:
a display unit for providing a screen output; and
a widget service determining unit for allowing a user to select the first application to be magnified through touch input command on a display screen, executing the first application to be magnified on one screen using a short circuit technique, magnifying the executed first application on the one screen according to the user's touch input command, driving the executed first application on the one screen according to the user's touch input command using the short circuit technique, and reducing the executed first application on the one screen according to the user's touch input command.

12. The apparatus of claim 11, wherein the widget service determining unit magnifies the executed first application to a maximum size on the one screen according to the user's touch input command.

13. The apparatus of claim 11, wherein the widget service determining unit executes the first application to be magnified on the one screen using the short circuit technique by meeting a request of the first application to be magnified after determining a service used by the first application to be magnified in advance.

14. The apparatus of claim 11, wherein the widget service determining unit drives the executed first application on the one screen according to the user's touch input command using the short circuit technique by meeting a request of the executed first application after determining a service used by the executed first application in advance.

15. The apparatus of claim 11, wherein the widget service determining unit drives the executed first application on the one screen according to the user's touch input command using the short circuit technique by providing the user's touch input command to the executed first application after determining a service used by the executed first application in advance.

16. The apparatus of claim 11, wherein the widget service determining unit allows a user to select a second application to be magnified through a screen touch input command, executes the second application to be magnified on one screen using the short circuit technique, magnifies the executed second application according to the user's touch input command, drives the executed second application on the one screen using the short circuit technique according to the user's touch input command, and reduces the executed second application on the one screen according to the user's touch input command.

17. The apparatus of claim 16, wherein the widget service determining unit magnifies the executed second application to a maximum size on the one screen according to the user's touch input command.

18. The apparatus of claim 16, wherein the widget service determining unit executes the second application to be magnified on the one screen using the short circuit technique by meeting a request of the second application to be magnified after determining a service used by the second application to be magnified in advance.

19. The apparatus of claim 16, wherein the widget service determining unit drives the executed second application on the one screen using the short circuit technique according to the user's touch input command by meeting a request of the executed second application after determining a service used by the executed second application in advance.

20. The apparatus of claim 16, wherein the widget service determining unit drives the executed second application on the one screen using the short circuit technique according to the user's touch input command by providing the user's touch input command to the executed second application after determining a service used by the executed second application in advance.
